(19) United States
(12) Patent Application Publication
(10) Pub. No.: US 2003/0167101 A1
(43) Pub. Date: Sep. 4, 2003

(54) Apparatus and method for transporting articles of the same type

(76) Inventor: Kurt Philipp, Rheinfelden (DE)

Correspondence Address: SIDLEY AUSTIN BROWN & WOOD LLP, 787 Seventh Avenue, New York, NY, 10019, US

(21) Appl. No.: 10/349,774

(22) Filed: Jan. 23, 2003

(30) Foreign Application Priority Data
Jan. 24, 2002 (CH) 2002 0114/02

(51) Int. Cl. G06F 7/00

(52) U.S. Cl. 700/213

(57) ABSTRACT

The apparatus serves for transporting articles of the same type, for example chocolate bars, and has a feed conveyor, a removal conveyor with a transverse conveyor running transversely to the end section of the feed conveyor, and a compensation device for arranging articles fed at regular or irregular time intervals by the feed conveyor at regular distances on the removal conveyor. The compensation device has two buffer stores and transfer means for transferring articles from the feed conveyor into the stores and from these onto the transverse conveyor. The two buffer stores are arranged together in a frame and have a plurality of intermittently movable storage units which are fastened by being suspended from a chain pair running vertically over a plurality of deflection rollers and each form a gondola train over at most half the length of the chain pair. The two chain pairs and hence also the storage units are arranged flush with one another and are each driven by means of a shaft, i.e. one drive is provided for the first, outer chain pair and one drive for the second, inner chain pair.

### BACKGROUND OF THE INVENTION

1. Field of the Invention

The invention relates to an apparatus for transporting articles of the same type. The articles may be, for example, chocolate bars which are transported from a production device to at least one packing device. However, instead of consisting of chocolate bars, the articles may consist of other sweet or non-sweet foods in the form of pieces, for example bakery articles, or of cans or other containers with any filling or of components for mechanical engineering, for example ball bearings, which are transported to a packing device or other processing device.

2. Description of the Prior Art

In the case of known apparatuses for the production and packing of chocolate bars, the bars produced by a production device are transported by means of a feed conveyor to chain stores and then through these to packing devices. Each chain store can be formed, for example, approximately according to DE 90 12 074 U and serves as a compensating device for compensating variations in the feed rate of bars or the packing rate of the packing device and of complete stoppages of the production device or of the packing device, lasting, for example, from 5 min to 45 min. Such a chain store typically has 150 to about 1200 gondolas or trays suspended from two continuous chains and intended for holding one row of bars each. Each chain is deflected by a plurality of chain wheels mounted in a frame and by a plurality of chain wheels mounted on vertically adjustable carriages and forms a number of loops.

The known apparatuses therefore have the disadvantages that the chain stores required for each packing device by permitting the passage of all required bars are large and expensive, give rise to high cleaning and maintenance costs and occupy a great deal of space. Furthermore, it takes a fairly long time after the start of the production device until the chain stores have been sufficiently filled and until chocolate bars reach the packing machine. In the case of the transport of other articles, similar problems and disadvantages may arise.

### SUMMARY OF THE INVENTION

It is the object of the invention to provide an apparatus which makes it possible to overcome disadvantages of the known apparatuses and in which the compensating device can be produced economically, which gives rise to as low cleaning and maintenance costs as possible and which occupies only a small amount of space.

This object is achieved, according to the invention, by an apparatus for transporting articles of the same type comprising a feed conveyor for feeding articles to a compensation device and a removal conveyor for removing articles from the compensation device, wherein the compensation device has two buffer stores and transport means for transferring the articles arriving from the feed conveyor alternatively into one of the two buffer stores at a loading station and from these to the removal conveyor at an unloading station, wherein the two buffer stores are arranged together in a frame, wherein each buffer store has a plurality of intermittently movable storage units which are fastened by being suspended from a chain pair running vertically over a plurality of deflection rollers and each form a gondola train over at most half the length of the chain pair, wherein the two chain pairs and hence also the storage units are arranged flush with one another and are each driven by means of a shaft, i.e. one drive is provided for the first, outer chain pair and one drive for the second, inner chain pair.

In an expedient further development of the subject of the invention, the feed conveyor is formed for transporting in succession individual rows or possibly successive groups of rows comprising two or more associated rows running transversely to the transport direction of the feed conveyor to the compensating device. During intended operation, the feed rate is, for example, about 20 to 50 rows or groups of rows per minute. Transfer means can then transfer the rows to the removal conveyor arranged behind the compensating device in the transport direction, in such a way that each transferred row is approximately or exactly in the transport direction of the removal conveyor and that any rows belonging to one and the same group of rows are arranged one behind the other on the removal conveyor. The compensating device need only be able to store a small number of articles or individual rows of articles or groups of rows to compensate variation in the articles fed by the feed conveyor and/or removed by the removal conveyor per unit time and/or short interruptions in the feed or in the removal. In an expedient embodiment of the subject of the invention, the compensating device is formed to store, for example, twenty to sixty individual articles or rows or groups of rows of said type which are fed in succession by the feed conveyor. The compensating device can furthermore preferably store and release that number of articles which is fed by the feed conveyor during intended ideal operation during a period which is preferably at least five seconds, preferably not more than sixty seconds and, for example, ten to thirty seconds. The compensating device according to the invention can accordingly be produced in a simple and economical manner, requires only a little space, gives rise to only a small amount of work for cleaning and maintenance and can be partly filled in a short time at the beginning of the feed and emptied in a short time at the end of the feed.

### BRIEF DESCRIPTION OF THE DRAWINGS

The subject of the invention and advantages of it are described below with reference to an embodiment shown in the drawings. In the drawings,

FIG. 1 shows a simplified side view of an apparatus for transporting and packing articles and

FIG. 2 shows a plan view of the apparatus shown in FIG. 1.

### DESCRIPTION OF THE PREFERRED EMBODIMENTS

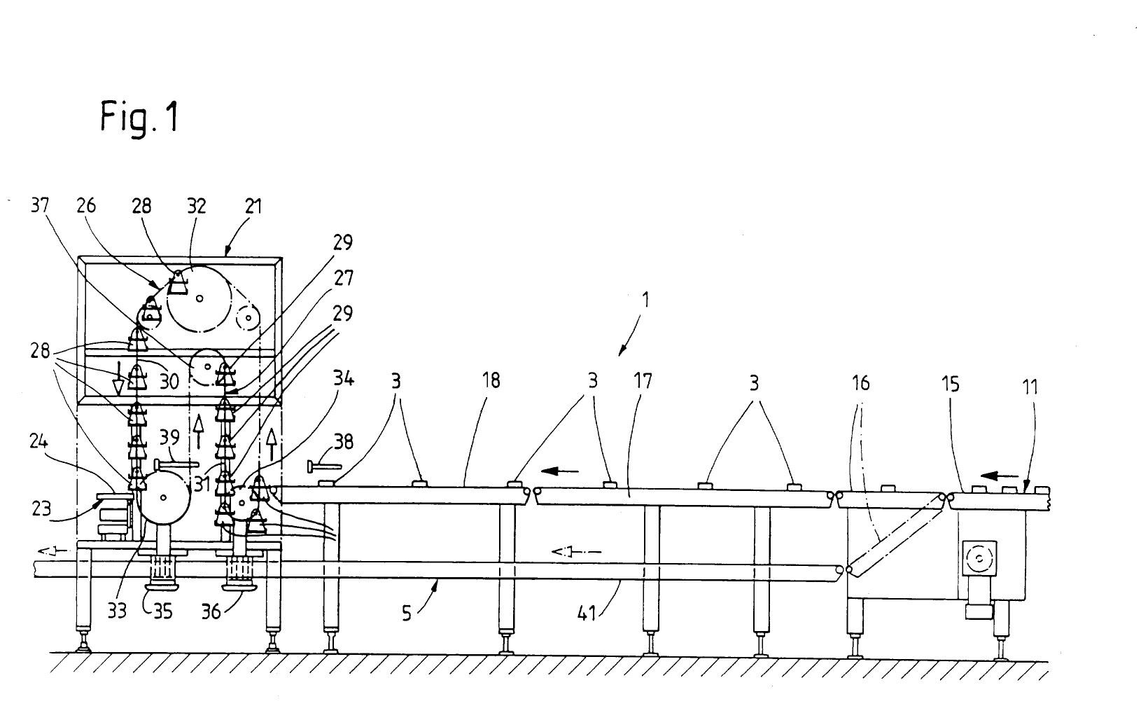

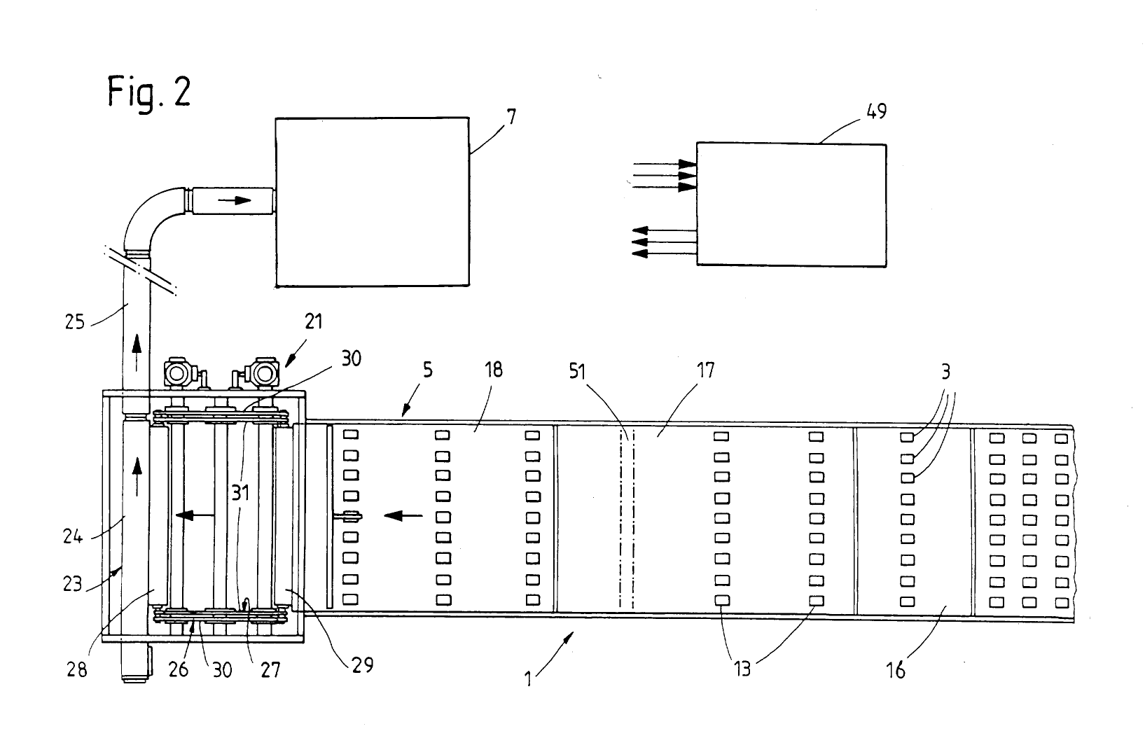

The apparatus 1 or installation 1 shown partly in FIGS. 1 and 2 serves for the production, transport and packing of articles 3, namely chocolate bars or the abovementioned products, and has a production device which is not shown, a transport means 5 and a plurality of packing devices, one of which is shown in FIG. 2 and is denoted by 7. The transport means 5 has a conveyor 11 comprising a number of parts or sections which are approximately horizontal or are inclined slightly relative to a horizontal plane. The production device is formed for producing the articles 3, for example unpacked chocolate bars, and arranging them on the conveyor 11 in rows 13 running transversely to the longitudinal and transport direction. A metal detection and removal device which is not shown is arranged on the conveyor 11 after the production device, based on the transport direction. This device can detect the presence of metal particles in a chocolate bar and has an ejection member for ejecting and removing a row 13. The conveyor 11 has a diverter 15 which is arranged along the transport path after the metal detection and removal device and comprises an adjustable diverter element 16. This is pivotable to two different pivot positions about a horizontal pivot axis. When the diverter element 16 is in the upper pivot position shown with solid lines in FIG. 1, the diverter element 16 is followed by a conveyor 17, of which at least the last end section 18 along the transport path is straight and horizontal. A compensation device 21 according to the invention, comprising a removal conveyor 23, is arranged at the end of the end section 18. Said removal conveyor has a transverse belt 24 at the beginning. Its transport direction is horizontal, straight and at right angles to the transport direction of the end section 18. The removal conveyor 23 furthermore has a gap-closing belt 25 following the transverse conveyor 24 and is connected at its end to the entrance of the packing device 7.

The transport elements of the various stated conveyor parts and sections of the conveyor 11 are formed at least for the most part by conveyor belts. This applies in particular to the feed conveyor 17 and the transverse conveyor 24. However, the conveyor parts can at least partly be formed from roller conveyors known in conveying technology.

According to the invention, the compensation device 21 has two buffer stores 26 and 27 which are arranged together in a frame and each have, for example, seven storage units 28 and 29, respectively, each of which serves for receiving and temporarily storing a row 13 of articles 3, i.e. chocolate bars. The storage units 28 and 29 preferably consist of gondolas with at least one support surface, for example two, and preferably up to six flat support surfaces, for the articles 3.

In the embodiment shown, the storage units or gondolas 28 and 29 are intrinsically stable bodies consisting of two product support plates on which the product rows can be stored and transported. The gondolas 28 and 29 are preferably fastened by being suspended with bolts from one continuous chain pair 30 or 31 each, so that, regardless of the position of the chains, they always retain their vertical position. They are moreover of low weight and can be manually suspended and removed relatively quickly. This is an important advantage from the hygiene point of view if it is intended to change the gondolas 28, 29, for example at a product change.

The gondolas 28 and 29 are each suspended at a certain distance on the chain pair 30 or 31 and form a gondola train each along at most half the length of the corresponding chain pair, the distance between the gondolas within a train depending on the height and length of the products to be handled.

According to the invention, the two chain pairs 30 and 31 and hence also the gondolas 28 and 29 are arranged flush with one another, i.e. they are deflected about common axes with which chain wheel pairs 32, 33, 34 mounted vertically one on top of the other in pairs in the frame are coordinated, i.e. one chain wheel pair for the buffer store 26 and one chain wheel pair for the store 27. The chain pairs 30, 31 are moreover each driven by means of a shaft, i.e. one drive is provided for the outer chain pair 30 and one drive for the inner chain pair 31.

The two drives are each formed by a controllable electric motor 35 in order to drive the two lower chain wheels 33 and 34 independently of one another.

The two buffer stores 26, 27 can if necessary also be deflected about at least one central deflection axis, for example can run around chain wheel pairs 37, in order thus to increase the storage capacity of the compensation device 21 while maintaining the dimensions.

Furthermore, a loading station and an unloading station belong to the compensation device 21. These stations can alternatively be arranged at the upper or lower end of the front or rear of the device 21.

The compensation device 21 furthermore has transfer means, shown only schematically, for transferring the articles 3 at the loading station from the feed conveyor 17 into the buffer store 27 or 28 and at the unloading station from these stores onto the transverse conveyor 24. The transfer means have two controllable pushing devices 38, 39. Each pushing device 38, 39 has a pusher which can be displaced horizontally and parallel to the transport direction of the end section 18 of the feed conveyor 17 by an adjusting device having a pneumatic cylinder or an electric motor. The pusher of the first pushing device 38 is present in the rest position so high above the feed conveyor end section 18 that the feed conveyor 17 can transport articles 3 under the pusher. This pusher is, for example, adjustable in height and can be lowered starting from the rest position almost to the surface of the conveyor belt of the feed conveyor end section. When the pusher has been lowered starting from its rest position after the passage of a row 13, the pusher can push these articles onto a support surface of an empty gondola 28 or 29 present in the transfer position. The pusher of the second pushing device 37 is present in the rest position on that side of the transverse conveyor 24 which faces the feed conveyor 17. When a gondola 28 or 29 with a row of articles 3 is present in the transfer position at the unloading station, the pusher of the second pushing device 37 can push these articles onto the transverse conveyor 24.

When the diverter element 16 of the diverter 15 is present in its lower pivot position shown by a dash-dot line in FIG. 1, a branch conveyor 41 connects to the diverter element. The branch conveyor 41 is connected to at least one additional packing device and preferably via at least one additional diverter to two or more additional packing devices. It is also possible for at least two and, for example, three or even more packing devices to be present altogether. A compensation device 21, a feed conveyor 17 leading to said device and a removal conveyor 23 leading away from the compensation device 21 are present for each additional packing device which is not shown, analogously to the situation for the packing device 7 shown.

The transport means 5 has controllable drive devices which are not shown and comprise electric motors for driving the various conveyor belts and any roller conveyors also present. Furthermore, detector means which are not shown are present. These have detectors arranged at various positions of the installation 1. These consist, for example, of light barriers or the like and can generate electric signals which show whether or not articles 3 are present at the relevant position. It has, for example, inter alia one detector each at the beginning and at the end of the horizontal feed conveyor end section 18. Furthermore, a detector may be present for determining whether or not a storage unit instantaneously present in the transfer position contains a row of articles. Moreover, for example, at least one detector which is not shown is arranged near the removal conveyor.

The apparatus furthermore has control means 49 which are shown schematically by a block in FIG. 2 and comprise, for example, manually actuatable control elements, electronic elements, for example at least one digital processor, display and recording devices and data memories as well as possibly pneumatic and/or hydraulic control elements, such as valves and the like. Electric cables and possibly fluid lines indicated by arrows in FIG. 2 connect the control means 49 to the production device which is not shown, the packing devices 7, the metal detection and removal device, the detectors and the drive and/or adjusting devices of the conveyor belts, of the roller conveyor(s), of the diverter(s) 15, of the or each compensation device 21 and of the pushing devices 38 and 39. During operation, the processor processes the signals fed to it by the detectors and can obtain information about the movements and speeds of the articles and the distances between them from said signals and the time sequence thereof. The control means 49 are moreover formed in such a way that the production, transport, storage and packing of the articles 3 can be controlled alternatively by at least one person with the aid of the control elements and/or automatically at least from time to time.

The operation of the apparatus or installation 1 and of the transport means 5 belonging to it will now be explained. First, the ideal operation which takes place in the ideal case will be described. During this operation, the production device continuously produces articles and feeds them at uniform time intervals to the conveyor 11, so that the articles 3 belonging to the same row and adjacent to one another are the same distance apart and that in particular the successive rows 13 are also identical distances apart. The conveyor 11 transports the articles through the metal detection and removal device, which is not shown, to the diverter 15. This distributes the articles 3 onto the feed conveyor 17 and the branch conveyor 41. The control means 49 control the diverter 15 in such a way that, during ideal operation, rows 13 reach the feed conveyor 17 at regular time intervals. The diverter feeds the same number of rows per unit time to the branch conveyor 41 for each packing device connected to it.

During ideal operation, the or each conveyor belt of the feed conveyor 17 runs continuously at constant speed, then carries rows following one another at identical distances and transports them at uniform time intervals and at constant transport rates to the compensation device 21.

When the compensation device 21 is empty on starting the apparatus, a gondola train, for example the gondola train of the buffer store 27, is present at the loading station and the other gondola train, in this case the gondola train of the buffer store 28, is present at the unloading station. When articles 3 arrive at the compensation device 21, the gondola train of the buffer store 27 is then first moved step by step and filled. The pushing device 38 pushes each row 13 of articles 3 which is transported under its pusher from the feed conveyor 17 onto a support surface of an empty gondola 29 present in the transfer position. The control means 49 control the drive device of the buffer store 27 in such a way that first all support surfaces of the first gondola 29 and then the respective next lowest gondola are filled step by step. If, after this filling process, all gondolas 29 carry rows of articles 3, the gondola train of the buffer store 27 is moved to the unloading station, at the same time the empty gondola train of the buffer store 26, which is positioned there, being conveyed to the loading station.

At the unloading station, the product rows 13 are then removed by means of the pushing device 39 from the buffer store 27 and placed on the transverse discharge belt 24 and fed to the packing machine 7 by a gap-closing belt 25. For this purpose, the gondola train is likewise positioned again synchronously at the discharge level so that row by row can be pushed out. During this removal, the gondola train of the buffer store 28 is present at the loading station in order to be filled with new product rows. This is effected simultaneously with the removal; thus, the production on the infeed side and the packing on the outflow side are decoupled from one another for a certain time. As soon as the gondola train of the store 26 is fully loaded, said buffer train immediately travels back to the unloading station and closes up with the gondola train of the store 27 which is present there and which, after unloading, travels back to the loading station to receive further product rows.

The ideal operation described above can be disturbed by various faults. For example, a chocolate bar containing metal particles, for example metal turnings or the like, can from time to time reach the metal detection and removal device. The device 14 then removes the row 13 with the metal-containing bar. There is then, for example on the feed conveyor 17, a gap 51, indicated by a dot-dash line in FIG. 2, at which a row 13 should actually be present. The control means 49 can detect the absence of a row on the basis of the signals which are supplied by the detectors arranged near the feed conveyor 11.

In this case, the compensation device 21 according to the invention is controlled in such a way that the chocolate bars 3 arriving on the horizontal conveyor 17 are placed row by row and without gaps in the gondola trains and are then transferred without queuing and likewise without gaps to the packing machine coordinated with the compensation device 21. This transfer is effected as a function of the operating state of the packing machines, so that feed and transfer compensation between the production machines and the packing machines can be ensured.

It is also possible that the feed rate of the articles fed by the feed conveyor and the packing rate of the packing device 7 temporarily differ from one another. The production rate of the production device may be temporarily slightly lower than during ideal operation, for example owing to some small fault, so that the feed rate of the articles transported by the feed conveyor 17 to the transverse conveyor 24 is lower than the packing rate of the packing device. In this case, the control means can, for example, control the compensation device 21 in such a way that, with constant unloading speed, the two gondola trains are loaded at the loading station temporarily with a lower frequency so that, in spite of a difference in frequencies, the articles reach the packing device at the time intervals intended in ideal operation.

It is also possible for the packing device to be temporarily operated more slowly than intended. This may occur, for example when the articles transported to the packing device rest on the removal conveyor slightly skew to the transport direction and then still have to be aligned before packing. During automatic operation, the control means 49 ensure in such a case that the transport of the section 25 of the removal conveyor 23 is temporarily slowed down or the frequency of unloading is temporarily reduced or the unloading is possibly even completely stopped for a short time.

On the basis of the above statements, it may be said in summary that the packing process can be locally decoupled from the production process for a short time during operation of the compensating device 21 according to the invention, in order to supply the respective packing device as far as possible continuously with the product rows.

As a result of this decoupling as a function of time, it is possible to protect the packing from discontinuities in the production flow. It is also possible to cope with brief stops in the packing unit without product rows being lost. Furthermore, the installation according to the invention makes it possible to bridge asynchronisms between production speed and packing speed and to compensate variations. Thus, the efficiency of individual workstations and in particular entire production lines can be substantially increased by means of the installation according to the invention.

The installation or apparatus can be modified in various ways. Thus, the maximum number of gondolas intended for the buffer stores 26 and 27 may be, for example, at most twenty, for example at most ten.

What is claimed is:

1. An apparatus for transporting articles of the same type comprising a feed conveyor for feeding articles to a compensation device and a removal conveyor for removing articles from the compensation device, wherein the compensation device has two buffer stores and transport means for transferring the articles arriving from the feed conveyor alternatively into one of the two buffer stores at a loading station and from these to the removal conveyor at an unloading station, wherein the two buffer stores are arranged together in a frame, wherein each buffer store has a plurality of intermittently movable storage units which are fastened by being suspended from a chain pair running vertically over a plurality of deflection rollers and each form a gondola train over at most half the length of the chain pair, wherein the two chain pairs and hence also the storage units are arranged flush with one another and are each driven by means of a shaft, i.e. one drive is provided for the first, outer chain pair and one drive for the second, inner chain pair.

2. The apparatus as claimed in claim 1, wherein control means are present, wherein the control means are connected to and formed with detector means and connected to and formed with controllable adjusting means of the buffer stores in order to control the apparatus automatically in such a way that the articles are arranged uniform distances apart on the removal conveyor even with irregular feed of the articles by the feed conveyor.

3. The apparatus as claimed in claim 1, wherein the storage units are formed from gondolas consisting of a plurality of product support plates and wherein the gondolas are fastened by being suspended with bolts from one continuous chain pair each, so that they always maintain their vertical position regardless of the position of the chains.

4. The apparatus as claimed in claim 1, wherein the two drives of the buffer stores are each formed by a controllable electric motor for driving the two lower chain wheels.

5. The apparatus as claimed in claim 1, wherein the buffer stores also run around at least one common central deflection axis with which further chain wheels are coordinated, in order thus to increase the storage capacity of the compensation device while maintaining the same dimensions.

6. The apparatus as claimed in claim 1, wherein the buffer stores have at most twenty storage units and, for example, at most ten storage units.
